(19) United States
(12) Patent Application Publication
(10) Pub. No.: US 2026/0195298 A1
(43) Pub. Date: Jul. 9, 2026

(54) SYSTEM AND METHOD FOR PERFORMING AN MPH-BASED LOOKUP OF RECORDS IN A DATABASE

(71) Applicant: Visa International Service Association, San Francisco, CA (US)

(72) Inventor: Zhengrong Yang, Austin, TX (US)

(73) Assignee: Visa International Service Association, San Francisco, CA (US)

(21) Appl. No.: 19/130,908

(22) PCT Filed: Nov. 18, 2022
(86) PCT No.: PCT/US22/50410

§ 371 Date: May 16, 2025

(51) Int. Cl. G06F 16/13

(52) U.S. Cl. CPC G06F 16/137

(57) ABSTRACT

In some embodiments, a system includes a processor and a non-transitory computer readable medium coupled to the processor, the non-transitory computer readable medium comprising code that constructs a minimum perfect hash (MPH)-based database file for use in an MPH database; generates, based upon MPH-based parameters, an MPH-based record for the MPH database file; generates, based on an MPH function and a first parameter of the MPH-based parameters and a second parameter of the MPH-based parameters, an MPH-based position index that maps to the MPH-based record; and utilizes the MPH-based position index to access the MPH-based record in the MPH database.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Modern database applications often operate on a vast amount of data in processing various record searching transactions. In some instances, the database applications may operate on over a billion records, depending on the nature of the records being searched for and the size of the database. As a result, latency issues often arise when accessing records and creating records for database applications. Being able to access memory efficiently is vital to providing records quickly and accurately. Therefore, a need exists to provide database applications that reduce latency when searching for records in large databases.

### BRIEF DESCRIPTION OF THE DRAWINGS

FIG. 1 illustrates a block diagram of a system in accordance with some embodiments.

FIG. 2 illustrates a block diagram of a minimum perfect hash (MPH)-based database construction and lookup unit of the system in FIG. 1 in accordance with some embodiments.

FIG. 3 is a flow diagram illustrating a method for constructing an MPH-based database used to perform an MPH-based lookup in accordance with some embodiments.

FIG. 4 is a flow diagram illustrating a method for performing an MPH-based database lookup of a record in accordance with some embodiments.

### DETAILED DESCRIPTION

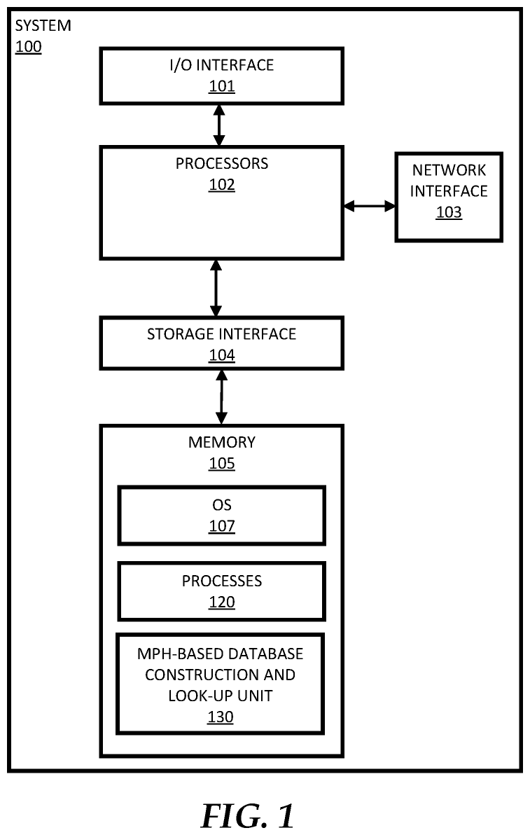

FIG. 1 illustrates a block diagram of an exemplary system 100 for implementing embodiments consistent with the present disclosure. In some embodiments, the system 100 includes an input/output (IO) interface 101, processor/s 102, a storage interface 104, a network interface 103, and memory 105. In some embodiments, memory 105 may include an operating system (OS) 107, processes 120, and a minimum perfect hash (MPH)-based database construction and lookup unit 130. In some nonlimiting embodiments or aspects, the system 100 may utilize the MPH-based database construction and lookup unit 130 to implement a method for constructing an MPH-based database and to perform an MPH-based database lookup of a record in the MPH-based database as described further herein.

In some embodiments, the processors 102 may comprise at least one data processor for executing program components for dynamic resource allocation at run time. The processors 102 may include specialized processing units such as integrated system (bus) controllers, memory management control units, floating point units, graphics processing units, digital signal processing units, etc. In some embodiments, the processors 102 may be disposed in communication with one or more input/output (I/O) devices (not shown) via an I/O interface 101. The I/O interface 101 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 101, the system 100 may communicate with one or more I/O devices. For example, an input device (not shown) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (not shown) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the processors 102 may be disposed in communication with a communication network or other type of network via a network interface 103. The network interface 103 may communicate with the communication network. The network interface 103 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 103 and the communication network, the system 100 may communicate with the one or more service operators.

In some non-limiting embodiments or aspects, the processors 102 may be disposed in communication with a memory 105 (e.g., RAM, ROM, etc.) via a storage interface 104. In some embodiments, the storage interface 104 may connect to memory 105 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, the memory 105 may store a collection of program or database components, including, without limitation, a user interface, an operating system 107, a web server, etc. In some non-limiting embodiments or aspects, the system 100 may store user/application data, such as the data, variables, records, etc. as described in this disclosure. Such databases may be implemented as fault-tolerant, relational, scalable, secure databases such as Oracle or Sybase.

In some embodiments, the operating system 107 may facilitate resource management and operation of the system 100. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® OS®, GOOGLE™ ANDROID™, BLACKBERRY® OS, or the like.

In some non-limiting embodiments or aspects, the system 100 may implement a web browser (not shown in the figures) stored program component. The web browser (not shown in the figures) may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

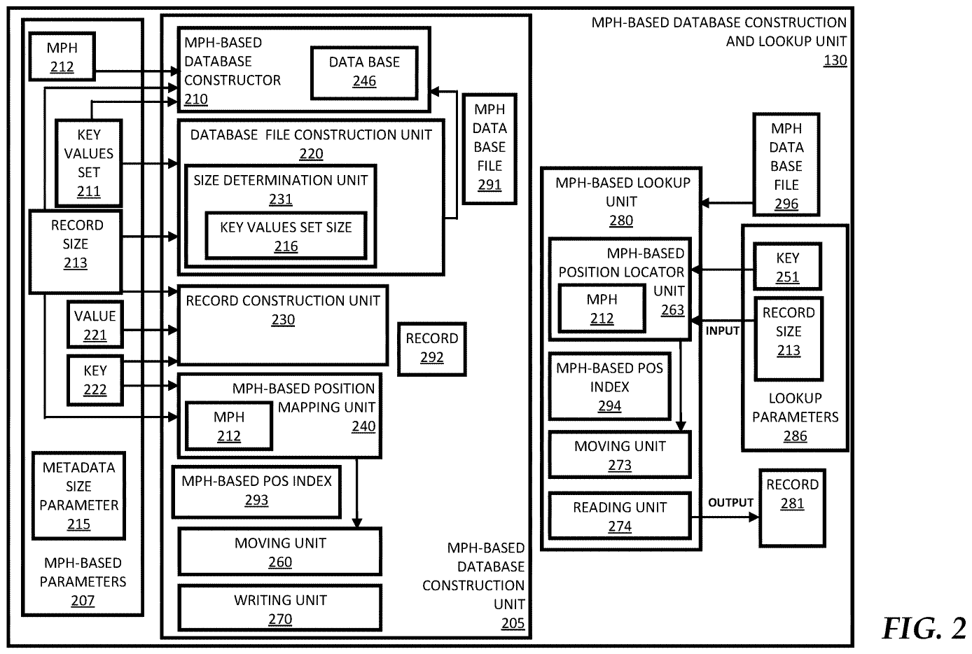

FIG. 2 illustrates a block diagram of the minimum perfect hash (MPH)-based database construction and lookup unit 130 of FIG. 1 in accordance with some embodiments. In some embodiments, the MPH-based database construction and lookup unit 130 is executable code configured to construct an MPH-based database and perform an MPH-based database lookup of a record in the MPH-based database in accordance with some embodiments. In some embodiments, the MPH-based database construction and lookup unit 130 includes an MPH-based database construction unit 205 and an MPH-based lookup unit 280. In some embodiments, the MPH-based database construction unit 205 is executable code configured to construct an MPH-based database 246 using an MPH-based position mapping unit 240 such that the MPH-based lookup unit 280 may perform the MPH-based database lookup of a record in the MPH-based database 246. In some embodiments, MPH-based lookup unit 280 is executable code configured to perform the MPH-based database lookup of a record in the MPH-based database 246 using the MPH-based position index generated using MPH-based position mapping unit 240.

In some embodiments, the MPH-based database construction unit 205 includes an MPH-based database constructor 210, a database file construction unit 220, a record construction unit 230, an MPH-based position mapping unit 240, a moving unit 260, and a writing unit 270. In some embodiments, the database file construction unit 220 is executable code configured to construct a database file (e.g., database file 291) containing records generated by the record construction unit 230. In some embodiments, the record construction unit 230 is executable code configured to generate an MPH-based record that is stored and positioned in the database file 291 using an MPH-based position index 293. In some embodiments, the MPH-based position mapping unit 240 is executable code configured to generate an MPH-based position index 293 that maps to the location of the MPH-based record in the database file 291. In some embodiments, the moving unit 260 is executable code configured to move to the location in the database file 291 indicated by the MPH-based position index 293 in order to allow writing unit 270 to write to a record 292 to the location indicated by the MPH-based position index 293. In some embodiments, the writing unit 270 is executable code configured to write a record 292 moved by the moving unit 260 to the position in the database file 291 indicated by the MPH-based position index 293. In some embodiments, the MPH-based database constructor 210, the database file construction unit 220, the record construction unit 230, the MPH-based position mapping unit 240, the moving unit 260, and the writing unit 270 are collectively configured to generate the MPH-based database 246 that is utilized by MPH-based lookup unit 280 to quickly lookup terabyte scale key value records. In some embodiments, by writing a record 292 to the database file 291 using the MPH-based position index 293 generated by MPH-based position mapping unit 240, the MPH-based lookup unit 280 is able to quickly access the record in the MPH-based database 246, which may be stored in, for example, a solid-state drive (SSD) or memory 105 of system 100 or other type of random access memory. Thus, in some embodiments, the records may be looked up utilizing a system that supports random access to memory, such, SSD in system 100.

In some embodiments, the MPH-based lookup unit 280 includes an MPH-based position locator unit 263, a moving unit 273, and a reading unit 274. In some embodiments, the MPH-based position locator unit 263 is executable code configured to utilize an MPH function 212 to ascertain the MPH-based position index 294 that is utilized to access a record requested by, for example, the user of the system 100. In some embodiments, the moving unit 273 is executable code configured to move to the location in the database file 291 of the MPH-based database 246 indicated by the MPH-based position index 294 generated by MPH-based position locator unit 263. In some embodiments, the reading unit 274 is executable code configured to read the record located at the position indicated by the MPH-based position index 294. In some embodiments, MPH-based position locator unit 263, the moving unit 273, and the reading unit 274 are collectively configured to lookup and output the record 281 for the MPH-based lookup unit 280.

In some embodiments, utilizing the MPH-based database construction unit 205, the MPH-based database construction and lookup unit 130 is configured to construct the MPH-based database 246 and store key/value pairs as records in a location indicated by the MPH-based position index 294. In some embodiments, MPH-based lookup unit 280 is able to lookup the records using the key (e.g., key 251) associated with the key/value pair for quick access to the records in the MPH-based database 246.

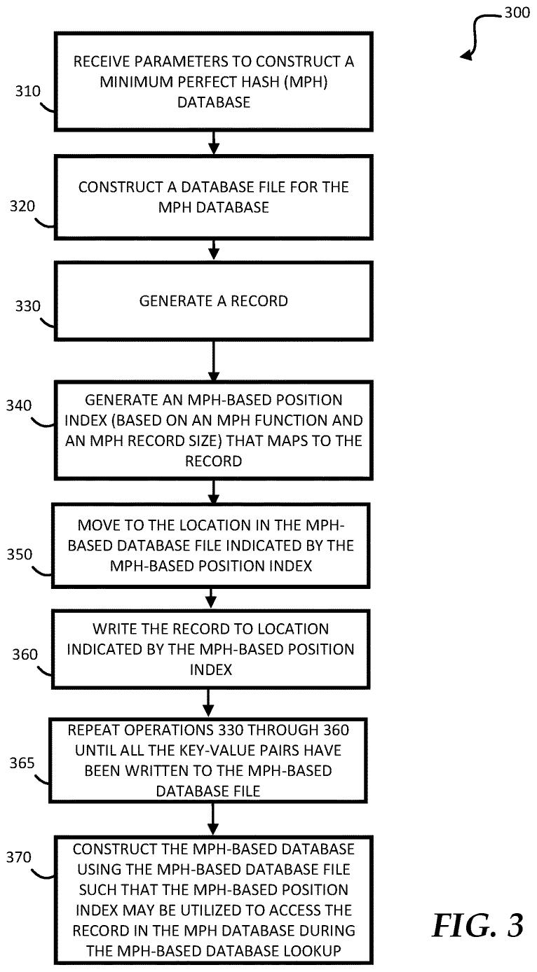

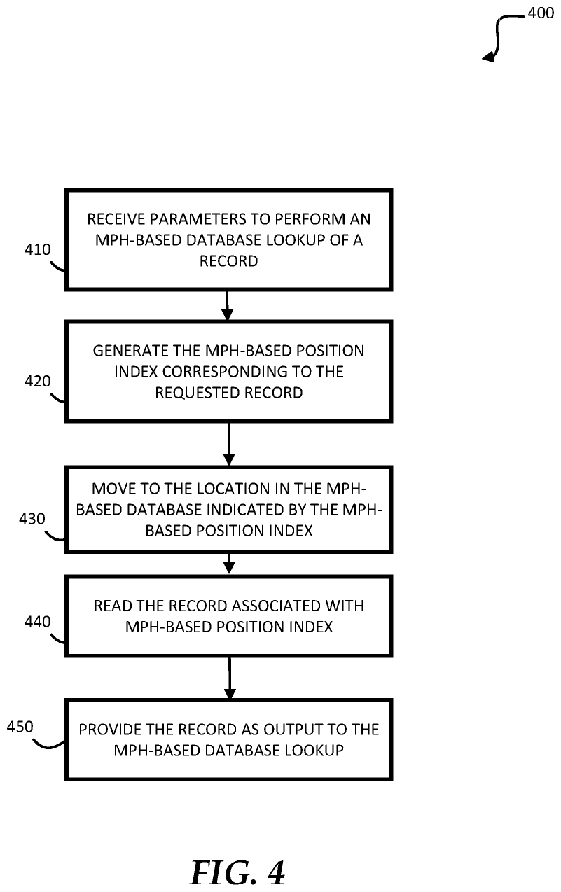

FIG. 3 is a flow diagram illustrating a method 300 for constructing the MPH-based database 246 in accordance with some embodiments. In some embodiments, the MPH-based database 246 is utilized by the MPH-based lookup unit 280 to perform an MPH-based lookup of FIG. 4 in accordance with some embodiments. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the method 300 is described with reference to the figures described herein.

In some embodiments, at operation 310, MPH-based database construction unit 205 receives MPH-based parameters 207 from a user of system 100 requesting the construction of an MPH-based database 246. In some embodiments, the MPH-based parameters 207 are database parameters that are utilized by the MPH-based database construction unit 205 of MPH-based database construction and lookup unit 130 to construct the MPH-based database 246. In some embodiments, the MPH-based parameters include a key 222, a value 221, and a record size parameter 213. In some embodiments, key 222 is a unique identifier of data used by the MPH-based database construction and lookup unit 130 to construct MPH-based database 246 and to access records in the MPH-based database 246. In some embodiments, the key 222 may be any suitable data (e.g., an account identifier, an alphanumeric identifier, a data object, a social security number, a name, etc.) for which a value (e.g., value 221) may be associated. In some embodiments, the value 221 is information (e.g., date of birth, credit score, address, etc.) associated with the key 222. In some embodiments, a key-value pair is a pair of related or associated data elements, such as, for example, a key 222 associated with a value 221. For example, for a key 222 that is a personal account number, a date of birth may be a value 221 associated with the personal account number, thus, the key-value pair includes key 222 and value 221. In some embodiments, the key-value set 211 is a set of the key-value pairs utilized to construct the MPH-based database 246. In some embodiments, the record size parameter 213 is the size of a record (e.g., record 292) that is created by the record construction unit 230. In some embodiments, the record size parameter 213 may be a byte value, such as, for example, 512 bytes or some other byte value entered by the user of system 100. In some embodiments, the record size parameter 213 may be dependent on the design configuration of the record 292 to be created by record construction unit 230. In some embodiments, after MPH-based database construction unit 205 receives MPH-based parameters 207 from the user of system 100, operation 310 proceeds to operation 320.

In some embodiments, at operation 320, database file construction unit 220 of MPH-based database construction unit 205 receives the record size parameter 213 and the key-value set 211 and utilizes the record size parameter 213 and key-value set 211 to construct a database file 291. In some embodiments, the database file 291 is a database file configured to contain records (e.g., record 292) generated by the record construction unit 230. In some embodiments, database file construction unit 220 is configured to construct the database file 291 by determining the size of the database file 291 to be constructed and utilizing a specialized function command (e.g., a new file function) in an in-memory data structure store, such as, for example, the Redis in-memory data structure store to construct the database file 291. For example, in some embodiments, database file construction unit 220 is configured to construct the database file 291 by inputting the record size parameter 213 and key-value set 211 into the new file function and utilizing the new file function (e.g., NewFile(size=recordSize_parameter_213*keyValues_211.size)) in Redis to generate database file 291. In some embodiments, the size of the database file 291 is calculated by size determination unit 231 by multiplying the record size parameter 213 times the size of the key-values set 211. In some embodiments, after the database file 291 has been constructed at operation 320, operation 320 proceeds to operation 330.

In some embodiments, after the database file 291 has been constructed by database file construction unit 220, at operation 330, record construction unit 230 receives the record size parameter 213, the key 222, and the value 221 and constructs a record 292. In some embodiments, the record 292 is a record that includes a key (e.g., key 222) and the associated value (e.g., value 221). In some embodiments, a record may be constructed by record construction unit 230 for each key-value pair in the key-values set 211. In some embodiments, record construction unit 230 is configured to construct the record 292 by utilizing a specialized function, such as, for example, a new records function (e.g., NewRecords(key_222, value_221, recordSize_parameter_213)), in an in-memory data structure store, such as, for example, the Redis in-memory data structure store. In some embodiments, after the record 292 has been constructed at operation 330, operation 330 proceeds to operation 340.

In some embodiments, at operation 340, MPH-based position mapping unit 240 receives key 222 and the record size parameter 213 and generates an MPH-based position index 293. In some embodiments, the MPH-based position index 293 is an index generated by the MPH-based position mapping unit 240 (based on the key 222 and the record size parameter 213) that is used to provide the position of a record 292 stored in a database file 291 of the MPH-based database 246. In some embodiments, MPH-based position mapping unit 240 is configured to generate the MPH-based position index 293 by multiplying the output of an MPH function 212 by the record size parameter 213. In some embodiments, the MPH function 212 is a minimum perfect hash function configured to map a static set of n keys into a set of m integer numbers without collisions, where m is greater than or equal to n. In some embodiments, the output of the MPH function 212 is a hash value. In some embodiments, the MPH function 212 may be a minimum perfect hash function, such as, for example, a BMZ MPH function, a BMZ8 MPH function, a CHM MPH function, a BRZ MPH function, an FCH MPH function, a BDZ MPH function, a CHD MPH function, or some other type of MPH function. In some embodiments, MPH function 212 receives the key 222 as input into the MPH function 212 and is multiplied by the record size parameter 213 to generate the MPH-based position index 293. In some embodiments, MPH-based position mapping unit 240 is configured to generate the MPH-based position index 293 by utilizing a specialized function, such as, for example, an MPH function (e.g., MPH_based_position_index_293=mph(key_222)*record_size_parameter_213), from an in-memory data structure store, such as, for example, the Redis in-memory data structure store. In some embodiments, after generating the MPH-based position index 293, MPH-based position mapping unit 240 provides the MPH-based position index 293 to moving unit 260 and operation 340 proceeds to operation 350.

In some embodiments, after receiving the MPH-based position index 293 from MPH-based position mapping unit 240, at operation 350, moving unit 260 utilizes the MPH-based position index 293 to move to the location in the database file 291 indicated by the MPH-based position index 293. In some embodiments, the moving unit 260 moves to the location indicated by the MPH-based position index 293 by utilizing a specialized function, such as, for example, moveToLocation function (e.g., dbFile.moveToLocation(MPH_based_position_index_293)), from an in-memory data structure store, such as, for example, the Redis in-memory data structure store. In some embodiments, after the moving unit 260 moves to the location indicated by the MPH-based position index 293, operation 350 proceeds to operation 360.

In some embodiments, at operation 360, writing unit 270 writes the record 292 to the location in the database file 291 indicated by the MPH-based position index 293. In some embodiments, the writing unit 270 writes to the location indicated by the MPH-based position index 293 by utilizing a specialized function, such as, for example, write function (e.g., dbFile.write(record_292)), from an in-memory data structure store, such as, for example, the Redis in-memory data structure store. In some embodiments, after writing unit 270 writes record 292 to the location in database file 291 indicated by the MPH-based position index 293, operation 360 proceeds to operation 365.

In some embodiments, at operation 365, MPH-based database construction unit 205 repeats operations 330 through 360 until all the records corresponding to the key-value pairs in the key-value set 211 have been written to database file 291 using the MPH-based position index 293. In some embodiments, the records written to database file 291 by writing unit 270 may now be accessed using the MPH-based database lookup operations described further in detail herein. In some embodiments, after the MPH-based database construction unit 205 has repeated operations 330 through 360 such that all the records corresponding to the key-value pairs in the key-value set 211 have been written into database file 291, operation 365 proceeds to operation 370.

In some embodiments, at operation 370, MPH-based database constructor 210 constructs the MPH-based database 246 using the database file 291. In some embodiments, the MPH-based database 246 is constructed by concatenating database file 291 with additional database files constructed by MPH-based database construction unit 205. In some embodiments, after the MPH-based database 246 has been constructed at operation 370, the MPH-based lookup unit 280 may utilize the MPH-based position index to access records (e.g., record 292) in the MPH-based database 246 generated by the MPH-based database construction unit 205. In some embodiments, the records in MPH-based database 246 are accessed using the MPH-based database lookup operations described further in detail herein with reference to FIG. 4.

FIG. 4 is a flow diagram illustrating a method 400 for performing an MPH-based database lookup in accordance with some embodiments. In some embodiments, the method 400 performs the MPH-based database lookup of the MPH-based database 246 constructed using method 300 of FIG. 3. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the method 300 is described with reference to the figures described herein.

In some embodiments, in order to commence the process of performing the MPH-based database lookup of a record 281 in the MPH-based database 246, at operation 410, MPH-based lookup unit 280 of MPH-based database construction and lookup unit 130 receives, in addition to the database file 296 to be searched in the MPH-based database 246, lookup parameters 286 to search for or lookup a record 281 in the MPH-based database 246. In some embodiments, the lookup parameters 286 include a key 251 and a record size parameter 213 associated with the requested record 281. In some embodiments, the key 251 may be provided by the user of system 100 that is requesting the search for the record 281 in MPH-based database 246. In some embodiments, the record size parameter 213 may be provided by the user of system 100 or by the MPH-based database construction and lookup unit 130 of system 100. In some embodiments, the record size parameter 213 associated with the database file 296 may be stored in, for example, memory 105 of system 100 for use by MPH-based construction and lookup unit 130. In some embodiments, after MPH-based lookup unit 280 receives lookup parameters 286 from the user of system 100, operation 410 proceeds to operation 420.

In some embodiments, at operation 420, MPH-based position locator unit 263 of MPH-based lookup unit 280 receives the lookup parameters 286 (e.g., key 251 and record size parameter 213) associated with the database file 296 and commences the process of generating the MPH-based position index 294. In some embodiments, the MPH-based position index 294 is an index generated using the MPH function 212 that provides the location of the record 281 in database file 296. In some embodiments, the database file 296 may be equivalent to the database file 291 created in method 300. In some embodiments, the MPH-based lookup unit 280 is configured to utilize MPH-based position index 294 to ascertain the position of the record 281 in the database file 296 of the MPH-based database 246. In some embodiments, the MPH-based position locator unit 263 is configured to utilize the key 251, the record size parameter 213, and MPH function 212 to generate the MPH-based position index 294. In some embodiments, MPH-based position locator unit 263 is configured to generate the MPH-based position index 294 by multiplying the output of MPH function 212 by the record size parameter 213. In some embodiments, the input to the MPH function 212 is the key 251 that is associated with the record being searched for by MPH-based lookup unit 280. In some embodiments, the MPH-based position locator unit 263 is configured to generate the MPH-based position index 294 by utilizing a specialized function, such as, for example, an MPH function (e.g., MPH_based_position_index_293=MPH(key_251)*recordSize_213), from an in-memory data structure store, such as, for example, the Redis in-memory data structure store. In some embodiments, the MPH function utilized by the MPH-based lookup unit 280 to generate the MPH-based position index 294 is the same MPH function utilized by the MPH-based database construction unit 205 to generate the MPH-based position index 293. In some embodiments, after generating the MPH-based position index 294, MPH-based position locator unit 263 provides the MPH-based position index 294 to moving unit 273 and operation 420 proceeds to operation 430.

In some embodiments, at operation 430, after receiving the MPH-based position index 294 from MPH-based position locator unit 263, moving unit 273 utilizes the MPH-based position index 294 to move to the location in the database file 296 indicated by the MPH-based position index 294. In some embodiments, the moving unit 273 moves to the location indicated by the MPH-based position index 294 by utilizing a specialized function, such as, for example, moveToLocation function (e.g., dbFile.moveToLocation(MPH_based_position_index_294)), from an in-memory data structure store, such as, for example, the Redis in-memory data structure store. In some embodiments, after the moving unit 273 moves to the location indicated by the MPH-based position index 294, operation 430 proceeds to operation 440.

In some embodiments, at operation 440, after moving unit 273 has moved to the location indicated by the MPH-based position index 294, reading unit 274 reads the record 281 located at the MPH-based position index 294. In some embodiments, the reading unit 274 reads the record 281 from the location indicated by the MPH-based position index 294 by utilizing a specialized function, such as, for example, a read function (e.g., dbFile.read(record_281)), from an in-memory data structure store, such as, for example, the Redis in-memory data structure store. In some embodiments, after the reading unit 274 reads the record 281 from the location indicated by the MPH-based position index 294, operation 440 proceeds to operation 450. In some embodiments, at operation 450, MPH-based lookup unit 280 provides the record 281 read by the reading unit 274 as output of the MPH-based lookup unit 280.

In some embodiments, referring back to operation 340 and operation 420, in addition to utilizing the MPH function 212 and the record size parameter 213 to generate the MPH-based position index 293 and the MPH-based position index 294, the MPH-based position mapping unit 240 and MPH-based position locator unit 263 may utilize a metadata size offset (e.g., metadata size parameter 215) to generate the MPH-based position index 293 and MPH-based position index 294. In some embodiments, the metadata size offset is a positioning offset configured to be used to account for metadata located at the beginning of the record 292. In some embodiments, the metadata size offset indicates the location where metadata added to the record 292 ends and the key and value data stored in the record 292 begin. In some embodiments, the metadata size offset is an offset that is added to the output of the MPH function 212 multiplied by the record size parameter 213 to indicate the starting location of the key and value stored in record 292 stored at the location of the MPH-based position index 293 and MPH-based position index 294 (e.g., MPH_based_position_index_293=meta_data_size_parameter_215+MPH(key_251)*recordSize_213). In some embodiments, the metadata-size-offset-updated MPH-based position index 293 and MPH-based position index 294 may be utilized to construct the MPH-based database 246 and access the records in the MPH-based database 246 using method 300 of FIG. 3 and method 400 of FIG. 4, respectively.

The embodiments described herein improve upon existing technology by allowing use of, for example, SSD to increase speed and performance for database construction and lookup. In some embodiments, the use of system 100 for database construction and lookup allows the embodiments described herein to improve computer capabilities by, for example, achieving microsecond constant time key lookup for terabytes scale using MPH functions and fast random access media, such as, SSD.

In some embodiments, a computer-implemented method, includes constructing a minimum perfect hash (MPH)-based database file for use in an MPH-based database; generating an MPH-based record for the MPH-based database file; generating, based on an MPH function and MPH-based parameters, an MPH-based position index that maps to the MPH-based record; and utilizing the MPH-based position index to access the MPH-based record in the MPH database.

In some embodiments of the computer-implemented method, the MPH-based parameters include a key and a record size parameter.

In some embodiments of the computer-implemented method, the MPH-based position index is generated by multiplying an output of an MPH function by the record size parameter.

In some embodiments of the computer-implemented method, the MPH function receives the key of the MPH-based parameters as input to the MPH function.

In some embodiments of the computer-implemented method, the MPH function is at least one of a BMZ MPH function, a BMZ8 MPH function, a CHM MPH function, a BRZ MPH function, an FCH MPH function, a BDZ MPH function, and a CHD MPH function.

In some embodiments, the computer-implemented method further includes moving to a record location indicated by the MPH-based position index.

In some embodiments, the computer-implemented method further includes writing the MPH-based record to the record location indicated by the MPH-based position index.

In some embodiments, the computer-implemented method further includes constructing the MPH-based database using the MPH-based database file.

In some embodiments, a system, includes a processor; and a non-transitory computer readable medium coupled to the processor, the non-transitory computer readable medium comprising code that: constructs a minimum perfect hash (MPH)-based database file for use in an MPH-based database; generates an MPH-based record for the MPH-based database file; generates, based on an MPH function and MPH-based parameters, an MPH-based position index that maps to the MPH-based record; and utilizes the MPH-based position index to access the MPH-based record in the MPH database.

In some embodiments of the system, the MPH-based parameters include a key and a record size parameter.

In some embodiments of the system, the non-transitory computer readable medium further comprises code that: generates the MPH-based position index by multiplying an output of an MPH function by the record size parameter.

In some embodiments of the system, the MPH function receives the key as input to the MPH function.

In some embodiments of the system, the MPH function is at least one of a BMZ MPH function, a BMZ8 MPH function, a CHM MPH function, a BRZ MPH function, an FCH MPH function, a BDZ MPH function, and a CHD MPH function.

In some embodiments of the system, the non-transitory computer readable medium further comprises code that: moves to a location indicated by the MPH-based position index.

In some embodiments of the system, the non-transitory computer readable medium further comprises code that: writes the MPH-based record to the location indicated by the MPH-based position index.

In some embodiments, an apparatus includes a minimum perfect hash (MPH) database construction unit configured to construct a minimum perfect hash (MPH) database for an MPH-based lookup; an MPH database file construction unit coupled to the MPH database construction unit, the MPH database file construction unit being configured to construct an MPH database file for the MPH database; an MPH record construction unit coupled to the MPH database file construction unit, the MPH record generating unit being configured to generate an MPH-based record; and an MPH-based position mapping unit coupled to the MPH-based record construction unit, wherein, based upon an MPH-based position index generated by the MPH-based position mapping unit, the MPH-based position index is utilized to access the MPH record in the MPH database during the MPH-based look-up.

In some embodiments of the apparatus, the MPH-based position index maps to the MPH-based record based on an MPH function and an MPH record size parameter.

In some embodiments of the apparatus, the MPH position mapping unit generates the MPH-based position index by multiplying an output of the MPH function by the MPH record size parameter.

In some embodiments of the apparatus, the MPH function receives a key as input to the MPH function.

In some embodiments of the apparatus, the MPH function is at least one of a BMZ MPH function, a BMZ8 MPH function, a CHM MPH function, a BRZ MPH function, an FCH MPH function, a BDZ MPH function, and a CHD MPH function.

What is claimed is:

1. A computer-implemented method, comprising:
constructing a minimum perfect hash (MPH)-based database file for use in an MPH-based database;
generating an MPH-based record for the MPH-based database file;
generating, based on an MPH function and MPH-based parameters, an MPH-based position index that maps to the MPH-based record; and
utilizing the MPH-based position index to access the MPH-based record in the MPH database.

2. The computer-implemented method of claim 1, wherein:
the MPH-based parameters include a key and a record size parameter.

3. The computer-implemented method of claim 2, wherein:
the MPH-based position index is generated by multiplying an output of an MPH function by the record size parameter.

4. The computer-implemented method of claim 3, wherein:
the MPH function receives the key of the MPH-based parameters as input to the MPH function.

5. The computer-implemented method of claim 4, wherein:
the MPH function is at least one of a BMZ MPH function, a BMZ8 MPH function, a CHM MPH function, a BRZ MPH function, an FCH MPH function, a BDZ MPH function, and a CHD MPH function.

6. The computer-implemented method of claim 5, further comprising:
moving to a record location indicated by the MPH-based position index.

7. The computer-implemented method of claim 6, further comprising:
writing the MPH-based record to the record location indicated by the MPH-based position index.

8. The computer-implemented method of claim 7, further comprising:
constructing the MPH-based database using the MPH-based database file.

9. A system, comprising:
a processor; and
a non-transitory computer readable medium coupled to the processor, the non-transitory computer readable medium comprising code that:
constructs a minimum perfect hash (MPH)-based database file for use in an MPH-based database;
generates an MPH-based record for the MPH-based database file;
generates, based on an MPH function and MPH-based parameters, an MPH-based position index that maps to the MPH-based record; and
utilizes the MPH-based position index to access the MPH-based record in the MPH database.

10. The system of claim 9, wherein:
the MPH-based parameters include a key and a record size parameter.

11. The system of claim 10, wherein the non-transitory computer readable medium further comprises code that:
generates the MPH-based position index by multiplying an output of an MPH function by the record size parameter.

12. The system of claim 11, wherein:
the MPH function receives the key as input to the MPH function.

13. The system of claim 12, wherein:
the MPH function is at least one of a BMZ MPH function, a BMZ8 MPH function, a CHM MPH function, a BRZ MPH function, an FCH MPH function, a BDZ MPH function, and a CHD MPH function.

14. The system of claim 13, wherein the non-transitory computer readable medium further comprises code that:
moves to a location indicated by the MPH-based position index.

15. The system of claim 14, wherein the non-transitory computer readable medium further comprises code that:
writes the MPH-based record to the location indicated by the MPH-based position index.

16. An apparatus, comprising:
a minimum perfect hash (MPH) database construction unit configured to construct a minimum perfect hash (MPH) database for an MPH-based lookup;
an MPH database file construction unit coupled to the MPH database construction unit, the MPH database file construction unit being configured to construct an MPH database file for the MPH database;
an MPH record construction unit coupled to the MPH database file construction unit, the MPH record generating unit being configured to generate an MPH-based record; and
an MPH-based position mapping unit coupled to the MPH-based record construction unit, wherein, based upon an MPH-based position index generated by the MPH-based position mapping unit, the MPH-based position index is utilized to access the MPH record in the MPH database during the MPH-based look-up.

17. The apparatus of claim 16, wherein:
the MPH-based position index maps to the MPH-based record based on an MPH function and an MPH record size parameter.

18. The apparatus of claim 17, wherein:
the MPH position mapping unit generates the MPH-based position index by multiplying an output of the MPH function by the MPH record size parameter.

19. The apparatus of claim 18, wherein:
the MPH function receives a key as input to the MPH function.

20. The apparatus of claim 19, wherein:
the MPH function is at least one of a BMZ MPH function, a BMZ8 MPH function, a CHM MPH function, a BRZ MPH function, an FCH MPH function, a BDZ MPH function, and a CHD MPH function.
